(19) United States
(12) Patent Application Publication
(10) Pub. No.: US 2025/0296385 A1
(43) Pub. Date: Sep. 25, 2025

(54) AXLE SYSTEM WITH A PARKING SYSTEM AND A DISCONNECT SYSTEM

(71) Applicant: Dana Automotive Systems Group, LLC, Maumee, OH (US)

(72) Inventors: Eric M. ENGERMAN, Plymouth, MI (US); Ryan D. NELMS, Weatherford, TX (US)

(21) Appl. No.: 19/088,814

(22) Filed: Mar. 24, 2025

Related U.S. Application Data
(60) Provisional application No. 63/569,502, filed on Mar. 25, 2024.

(51) Int. Cl. B60B 35/12; B60K 1/00; B60K 17/02; B60K 17/16; B60L 50/60; B60T 1/00; F16D 28/00; F16D 47/04

(52) U.S. Cl. CPC B60B 35/125; B60K 1/00; B60K 17/02; B60K 17/16; B60L 50/60; B60T 1/005; F16D 28/00; F16D 47/04

(57) ABSTRACT

Methods and systems for provide an axle system operated by a single motor to independently operate both a parking system and a disconnect system by changing rotation of a motor shaft and a method for controlling parking operation and clutch operation using the single motor. In another embodiment, the approaches disclosed herein include a line of axles wherein different variants of the electric axles may be configured with one of a parking system and a disconnect system, both the parking system and the disconnect system, and neither of the parking system and the disconnect system.

### CROSS REFERENCE TO RELATED APPLICATIONS

The present application claims priority to U.S. Provisional Application No. 63/569,502, entitled “AXLE SYSTEM WITH A PARKING SYSTEM AND A DISCONNECT SYSTEM”, and filed on Mar. 25, 2024. The entire contents of the above-listed application are hereby incorporated by reference for all purposes.

### TECHNICAL FIELD

The present disclosure relates generally to an axle with one of or both of a parking system and disconnect system.

### BACKGROUND AND SUMMARY

Vehicles include park lock mechanisms to prevent vehicle movement when the vehicle is stationary by engaging a park lock gear in the transmission and disconnect assemblies have been employed in certain vehicle platforms to reduce losses in the powertrain. These disconnect assemblies may be used in combustion engine powertrains as well as electric vehicle powertrains. Certain electric drive units with permanent magnet motors may specifically make use of disconnect assemblies to decrease losses in the powertrain when motive power generation is not desired

Existing transmissions typically include axles with one of a parking system and a disconnect system due to spacial constraints. The inventor has recognized the aforementioned issues with previous electric axles and developed a parking and disconnect system with a modular and adaptable arrangement that may be integrated into an electric axle system of a vehicle.

In one embodiment, the approaches disclosed herein provide an axle system operated by a single actuator motor to independently operate both a parking system and a disconnect system by changing rotation of a motor shaft. In another embodiment, the approaches disclosed herein include a front axle wherein different variants of the front axle may be configured with one of a parking system and a disconnect system, both the parking system and the disconnect system, and neither of the parking system and the disconnect system.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF DRAWINGS

FIG. 1 shows a schematic of an exemplary vehicle;

FIG. 2A shows a schematic of an axle system with a parking and disconnect system;

FIG. 2B shows a perspective view of the axle system of FIG. 2A;

FIG. 3 shows a side view of the axle system of FIG. 2B;

FIG. 4 shows an example disconnect system integrated in the parking and disconnect system.

FIG. 5A shows a first example of an electric axle that integrates the parking and disconnect system;

FIG. 5B shows a second example of an electric axle that integrates the parking and disconnect system;

FIG. 5C shows a first adaptor shaft integrated within the electric axles of FIGS. 5A and 5B;

FIG. 6A shows a third example of an electric axle that integrates a parking and disconnect system;

FIG. 6B shows a fourth example of an electric axle that integrates a parking and disconnect system;

FIG. 6C shows a second adaptor shaft of the integrated within the electric axles of FIGS. 6A and 6B;

FIG. 7 shows a cross section of the parking and disconnect system of FIG. 5B and a first power path wherein a disconnect system is activated; and

FIG. 8 shows a cross section of the parking and disconnect system of FIG. 5B and a first power path wherein a parking system is activated.

### DETAILED DESCRIPTION

Systems are provided for a parking and disconnect system comprising one of a parking system and a disconnect system or both the parking system and disconnect system wherein both the parking system and disconnect system are operated with a single actuator motor. In this way, the parking system may be operated by rotating the motor shaft coupled to the actuator motor in a first direction and the disconnect system may be operated by rotating the motor coupled to the actuator motor in a second direction, the first direction being opposite of the first direction. The parking and disconnect system may be integrated in a line of axles that include a first transmission, a second transmission, a third transmission, and a fourth transmission that vary from each other by substituting particular components of the respective transmission. More specifically, the line of axles is configured to integrate the parking and disconnect system as well as to not integrate the parking and disconnect system. For example, the first transmission may include only the disconnect system and not the parking system, the second transmission may include both the parking system and the disconnect system, the third transmission may include only the parking system and not the disconnect system, and the fourth transmission may include neither of the parking system and the disconnect system.

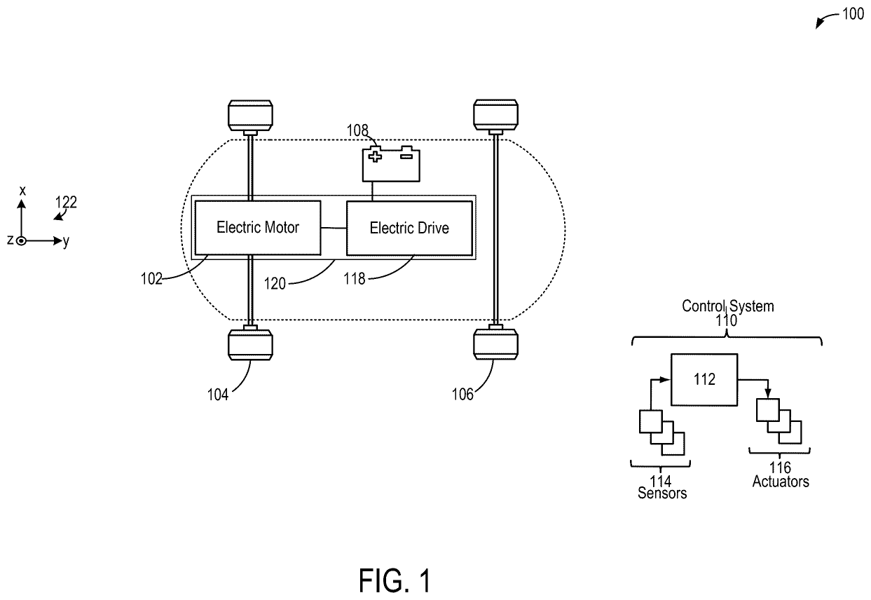

FIGS. 1-5B, FIG. 6A, FIG. 6B, FIG. 7 and FIG. 8 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

Turning now to the figures, FIG. 1 shows a schematic depiction of a vehicle system 100 comprising an electric drive 118, a traction battery 108, and an electric motor 102 that can derive propulsion power from an electric motor 102 (e.g., a drive motor). In one embodiment, electric motor 102 may be a traction motor. Electric motor 102 receives electrical power from a traction battery 108 to provide torque to front vehicle wheels 104. Electric motor 102 may also be operated as a generator to provide electrical power to charge traction battery 108, for example, during a braking operation. It should be appreciated that while FIG. 1 depicts an electric motor 102 mounted in a front wheel drive configuration, other configurations are possible, such as employing electric motor 102 in a rear wheel configuration, or in a configuration in which there is an electric motor mounted to both the rear vehicle wheels 106 and front vehicle wheels 104. In particular, the electric motor 102 may be mounted in a front axle wherein the front axle includes a parking and disconnect system wherein both of the parking system and the disconnect system may be activated with a single actuator motor by rotating the motor shaft coupled to the actuator motor in different directions.

Electric motor 102 may include a gearbox integrated therein. Additionally or alternatively, the electric motor 102 may be coupled to an outside of a transmission/gearbox housing 120. The integrated gearbox may include one or more input speed reduction gear sets. Electric motor 102 may also include at least one clutch.

Controller 112 may send a signal to an actuator of the clutch(es) to engage or disengage the clutch(es), so as to couple or decouple power transmission from the electric motor 102 to the rear vehicle wheels 106 or the front vehicle wheels 104. Additionally or alternatively, there may be multiple traction batteries configured to provide power to different driven wheels, wherein power to the wheels may be predicated based on traction at the wheels, driver demand, and other conditions.

Controller 112 may form a portion of a control system 110. Control system 110 is shown receiving information from a plurality of sensors 114 and sending control signals to a plurality of actuators 116. As one example, the plurality of sensors 114 may include sensors such as a battery level sensor, clutch activation sensor, etc. As another example, the actuators may include the clutch, etc. The controller 112 may receive input data from the various sensors, process the input data, and trigger the actuators in response to the processed input data based on instruction or code programmed therein corresponding to one or more routines. An axis 122 is provided in FIG. 1 for reference. The z-axis may be a vertical axis (e.g., parallel to a gravitational axis), the x-axis may be a lateral axis (e.g., horizontal axis), and/or the y-axis may be a longitudinal axis, in one example). However, the axes may have other orientations, in other examples.

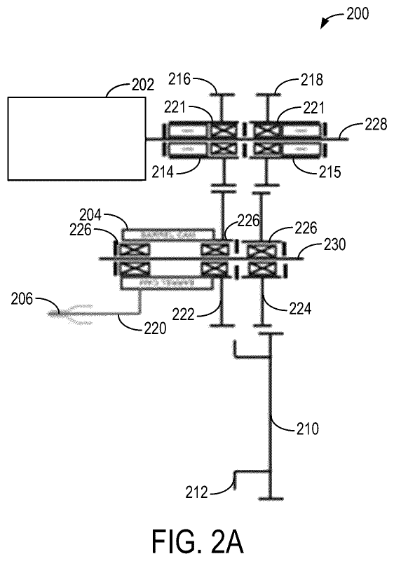

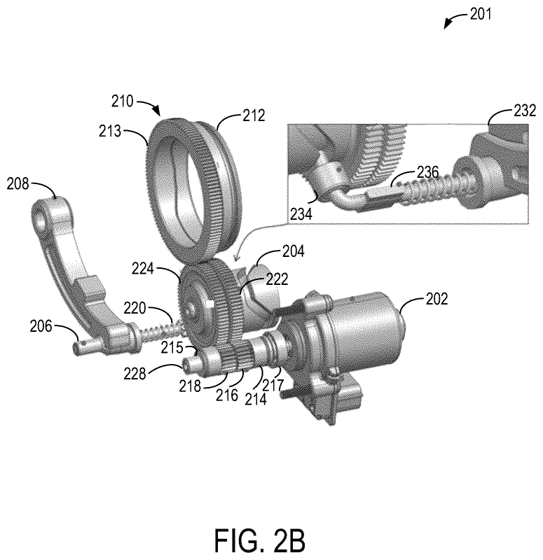

Referring now to FIG. 2A, a diagram of an exemplary parking and disconnect system 200 is shown. The parking and disconnect system 200 includes both a parking system and a disconnect system. However, in other embodiments of the parking and disconnect system 200, the parking and disconnect system may include one of the parking system and the disconnect system. The parking and disconnect system may include a motor shaft 228 coupled to an actuator motor 202. Bearings 221, a first needle one-way clutch 214, a first pinion gear 216, a second pinion gear 218, and a second needle one-way clutch 215 may be coupled to the motor shaft 228.

The first pinion gear 216 is positioned between the first needle one-way clutch 214 and the second pinion gear 218. The second pinion gear 218 is positioned between the first pinion gear 216 and the second needle one-way clutch 215. The first pinion gear 216 may surround one bearing of bearings 221 and the second pinion gear 218 may surround another bearing of bearings 221. Bearings 221 may support and facilitate rotation of the first pinion gear 216, the second pinion gear 218, and the motor shaft 228.

The first needle one-way clutch 214 and the second needle one-way clutch 215 may be positioned at either end of the motor shaft 228 to support and facilitate rotation of the motor shaft 228. More specifically, the first needle one-way clutch 214 is positioned relative to the first pinion gear on the motor shaft 228 to enable the first pinion gear to rotate in only the first direction and the second needle one-way clutch 215 is positioned relative to the second pinion gear on the motor shaft to enable the second pinion gear to rotate in only the second direction. In particular, the first needle one-way clutch 214 may be pressed with the first pinion gear 216 to enable rotation of the motor shaft 228 in a first direction and the second one-way needle clutch may be pressed with the second pinion gear 218 to enable rotation of the motor shaft in a second direction, the first direction being opposite of the second direction. In this way, rotation of the motor shaft 228 in the first direction via the actuator motor 202 may activate the parking system and rotation of the motor shaft in the second direction via the actuator motor may activate the disconnect system.

The parking and disconnect system 200 may further include a shaft 230 wherein a barrel cam 204, a first gear 222, an idler gear 224, and bearings 226 are coupled to. The first gear 222 may be coupled to the barrel cam 204. Bearings 226 may support and facilitate rotation of the shaft 230, and thus the first gear 222, and the barrel cam 204 coupled thereto. The barrel cam 204 is positioned at one end of the shaft 230 and the idler gear 224 is positioned at the opposite end of the shaft 230. The first gear 222 is positioned between the barrel cam 204 and the idler gear 224. The first gear 222 and the idler gear 224 are arranged on the shaft 230 such that the first gear engages 222 with the first pinion gear 216 and the idler gear 224 engages with the second pinion gear 218. The barrel cam 204 is coupled to a ratchet spring and rod 220, the ratchet spring and rod 220 being coupled to a park pawl cone 206. In this way, the rod may slide instead of rotating. Further, the idler gear 224 may be arranged to engage with a second gear 210. One end 212 of the second gear 210 functions as a face cam in the disconnect system as will be described herein with respect to FIG. 2B.

FIG. 2B shows a perspective view 201 of the parking and disconnect system 200 of FIG. 2A. Components of the parking and disconnect system 200 described in FIG. 2A may be omitted for brevity. As described herein, the actuator motor 202 rotates the motor shaft 228 in the first direction to activate the parking system and the actuator motor rotates the motor shaft in the second direction to activate the disconnect system. In this way, actuation of the parking system does not affect actuation of the disconnect system. The motor shaft 228 is coupled to a first bearing 217 positioned at one end of the motor shaft 228, the first needle one-way clutch 214, the first pinion gear 216, the second pinion gear 218, and the second needle one-way clutch 215 positioned at another end of the motor shaft, as depicted. The first bearing 217 is positioned beside the actuator motor 202 and is different from bearings 221 but similarly helps facilitate rotation of the motor shaft 228.

The parking system of the parking and disconnect system 200 may comprise the barrel cam 204 coupled to the park pawl cone 206 via the ratchet spring and rod 220, a park gear (not shown), and a park pawl 208 coupled to the park pawl cone wherein adjustment of the position of the park pawl cone engages the park pawl and the park gear. Due to engagement of the first pinion gear 216 and the first gear 222, rotation of the motor shaft 228 in a first direction may cause the first gear 222 to rotate in the first direction. In turn, the barrel cam 204 coupled to the first gear 222 rotates. Turning to view 232, the view 232 depicts a cam follower 234 positioned at an end of the ratchet spring and rod 220 that is closest to the barrel cam 204 and an anti-rotation component 236 coupled to the rod at one end of the ratchet spring of the ratchet spring and rod 220.

The cam follower 234 transforms the rotary motion of the barrel cam 204 into linear motion, which results in linear sliding of the ratchet spring and rod 220. Since the ratchet spring and rod 220 is coupled to the park pawl cone 206, the position of the park pawl cone is adjusted due to the linear motion of the ratchet spring and rod 220. In this way, rotation of the motor shaft 228 in the first direction results in the park pawl cone 206 being pulled in an out at various points in a rotation cycle of the motor shaft 228, and, thus the first pinion gear 216 and the first gear 222. In turn, the park pawl 208 engages with the park gear (not shown). The rotation cycle is the duration of time wherein the motor shaft is rotating in one of the first direction and the second direction. In response to the motor shaft 228 rotating in the first direction, the parking system alternates between being activated and deactivated during the rotation cycle of the motor shaft.

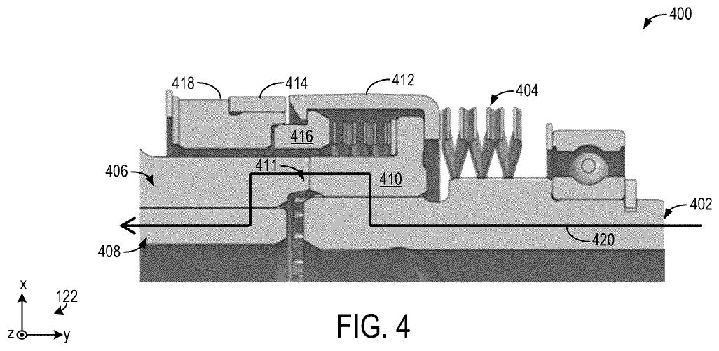

The disconnect system may comprise the second gear 210, a dog clutch (not shown), and an actuator that engages the dog clutch. Due to engagement of the second pinion gear 218 and the idler gear 224, rotation of the motor shaft 228 in a second direction may cause the idler gear 224 to rotate in the second direction. In turn, the second gear 210 engaged with the idler gear 224 rotates, activating the disconnect system. One end of the of the second gear 210 functions as a gear cam and the other end of the second gear function as a face cam. For example, an end 213 may function as the gear cam and the end 212 may function as the face cam. The disconnect system is described in greater detail in FIG. 4.

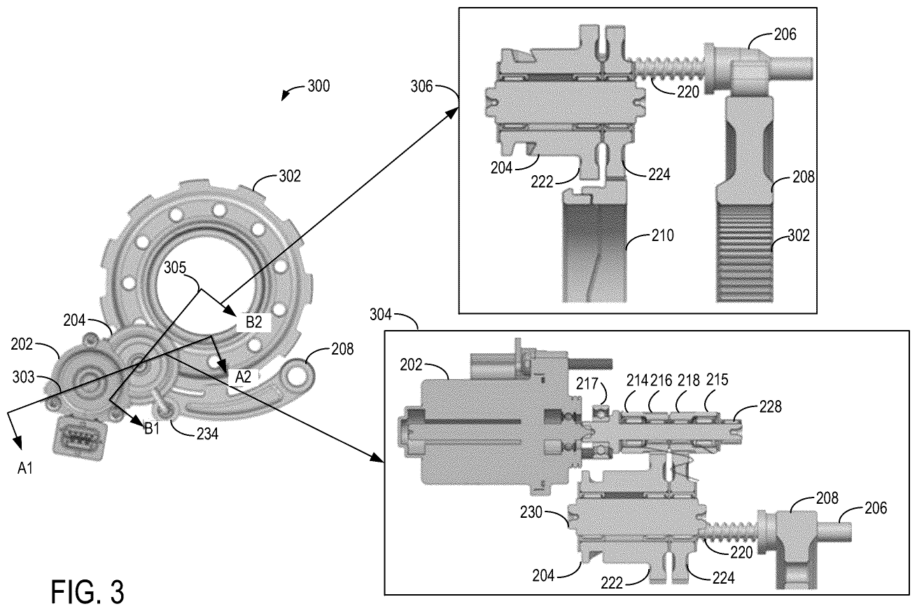

FIG. 3 shows a side view 300 of the parking and disconnect system illustrated in FIGS. 2A and 2B. Parking system components included in FIGS. 2A and 2B may be omitted for brevity. The side view 300 illustrates the arrangement of the actuator motor relative to the various components of the parking system and the engagement of a park gear 302 and the park pawl 208. With regards to the arrangement of the actuator motor relative to the parking system, the actuator motor 202, the motor shaft coupled to the actuator motor, and the various components coupled to the motor shaft as depicted in FIGS. 2A and 2B are not coaxial with the various component of the parking system, including the barrel cam 204, the cam follower 234, the park pawl 208, and a park gear 302. Additionally, the different components of the parking system are not coaxial with each other either. In particular, the barrel cam 204 is not coaxial with the park gear 302. Instead, the axis wherein the barrel cam 204 resides is offset from the axis wherein the park gear 302 resides. The side view 300 further depicts a first cross section 304 of a first portion 303 of the parking system and a second cross section 306 of a second portion 305 of the axle assembly.

The first portion 303 extends from a point A1 to a point A2 and the second portion 305 extends from a point B1 to a point B2. The first cross section 304 depicts the various components illustrated in FIGS. 2A and 2B, including the actuator motor 202, the motor shaft 228, the first bearing 217, the first needle one-way clutch 214, the first pinion gear 216, the second pinion gear 218, the second needle one-way clutch 215, the first gear 222, the idler gear 224 as well as some of the components of the parking system, including the barrel cam 204, the ratchet spring and rod 220, the park pawl cone 206, and the park pawl 208.

The axis of rotation of the barrel cam 204 is parallel to the axis of rotation of the motor shaft 228. The axis of rotation of the barrel cam 204 is not coaxial with the ratchet spring and rod 220 and the park pawl cone 206. However, due to the park pawl cone being coupled to an end of the ratchet spring and rod 220, the park pawl cone 206 is coaxial with the ratchet spring and rod 220. The first cross section 304 depicts the first needle one-way clutch 214 and the second needle one-way clutch 215 which may include gears (e.g., first pinion gear 216 and second pinion gear 218) that are pressed in a certain way to prevent the gears from being mounted in an incorrect direction.

The second cross section 306 depicts the various components illustrated in FIGS. 2A and 2B, including the first gear 222, the idler gear 224 as well as some of the components of the parking system, including the barrel cam 204, the ratchet spring and rod 220, the park pawl cone 206, the park pawl 208, and the park gear 302, and the disconnect system (e.g. the second gear). The second cross section 306 depicts the park pawl 208 being engaged with the park gear 302. The park pawl 208 is arranged with the park pawl cone 206 such that that park pawl 208 is orthogonal to the park pawl cone 206. In the second cross section 306, the second gear 210 of the disconnect system is parallel to the park pawl 208 and the park gear 302 when the park pawl is in an engaged state with the park gear.

FIG. 4 shows an example of a disconnect system 400. The disconnect system 400 surrounds one end of a transmission shaft 402 coupled to an electric motor at the other end of the transmission shaft relative to the disconnect system, a portion of an adaptor shaft 406, and one end of a sun gear shaft 408. The disconnect system 400 includes the second gear 210, a dog clutch 410, and an actuator that engages and disengages the dog clutch. The actuator may comprise the engagement spring 404, and the spring retainer 412.

In particular, the dog clutch 410 circumferentially surrounds one end of the transmission shaft 402 and the spring retainer 412 circumferentially surround the dog clutch 410 and the portion of the transmission shaft wherein the dog clutch surrounds. The engagement spring 404 is positioned to a right of the spring retainer 412 and surrounds a portion of the transmission shaft 402 wherefrom the engagement spring is located. A sliding cam 416 surrounds one end of the adaptor shaft 406 and one end of the sun gear shaft 408 on one side of an interface 411 (e.g., to the left of the interface 411) between the adaptor shaft and the transmission shaft 402.

The sliding cam 416 also surrounds one end of the dog clutch 410 and the transmission shaft 402 at another side of the interface 411 (e.g., to the right of the interface 411) between the adaptor shaft 406 and the transmission shaft 402. The sliding cam 416 is radially positioned between the dog clutch 410 and the spring retainer 412 on one side of the sliding cam (e.g., to the right of the interface 411). Further, the sliding cam 416 is positioned beside a rotating cam 418 to a left of the rotating cam. The rotating cam 418 may be a rotating cam and gear. The rotating cam 418 circumferentially surrounds a portion of the adaptor shaft 406 and a portion of the sun gear shaft 408 positioned to a left the sliding cam 416, and thus the interface 411. A bushing 414 is axially positioned between the rotating cam 418 and the spring retainer 412 and circumferentially surrounds a portion of the rotating cam 418, the adaptor shaft 406, and the sun gear shaft 408 wherefrom the bushing is located.

In response to the motor shaft 228 rotating in the second direction, the disconnect system alternates between being activated and deactivated during the rotation cycle of the motor shaft. As mentioned herein, the rotation cycle is the duration of time wherein the motor shaft is rotating in one of the first direction and the second direction. Accordingly, during the rotation cycle in the second direction, the dog clutch 410 is engaged 206 enabling torque from the electric motor to be transmitted according to the power path 420. In particular, the power path 420 includes torque from the electric motor being transmitted from the transmission shaft 402 to the dog clutch 410, from the dog clutch 410 to the adaptor shaft 406, from the adaptor shaft 406 to the sun gear shaft 408, and from the sun gear shaft 408 to wheels positioned upstream from the disconnect system rendering the disconnect system inactive. At other times during the rotation cycle in the second direction, dog clutch 410 is disengaged, rendering the disconnect system active and preventing torque from being transmitted upstream from the transmission shaft 402.

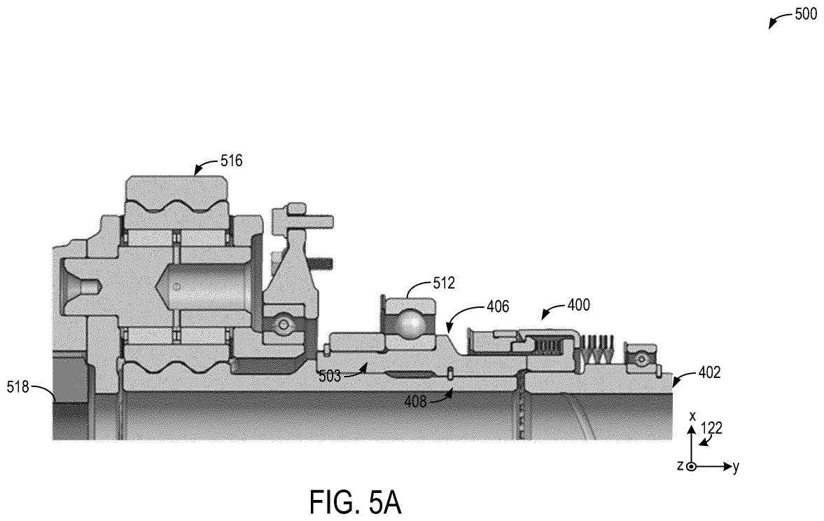

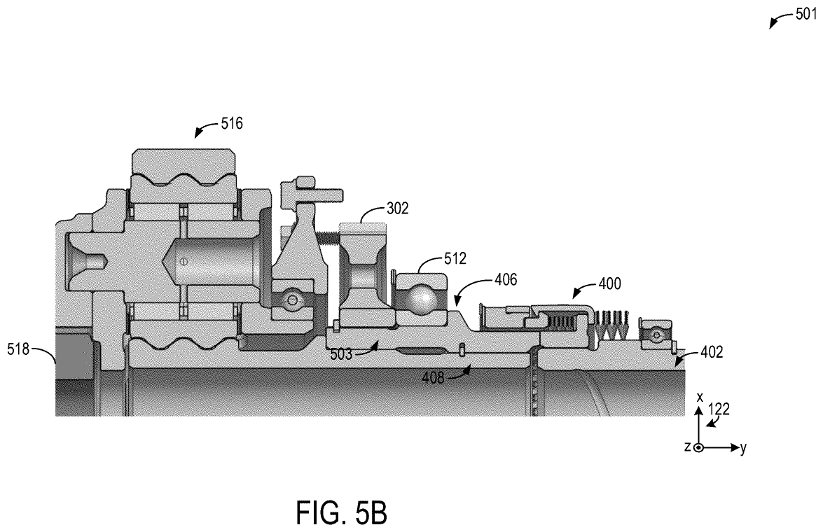

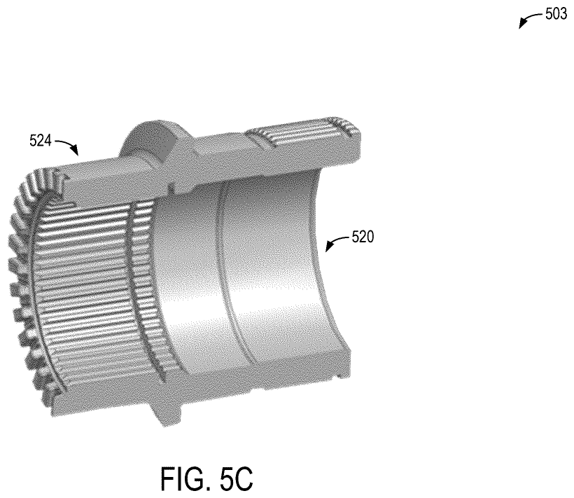

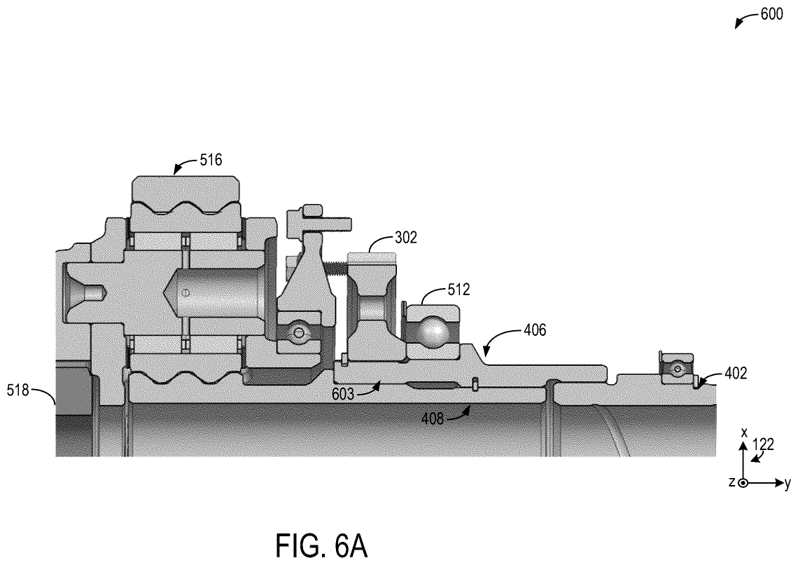

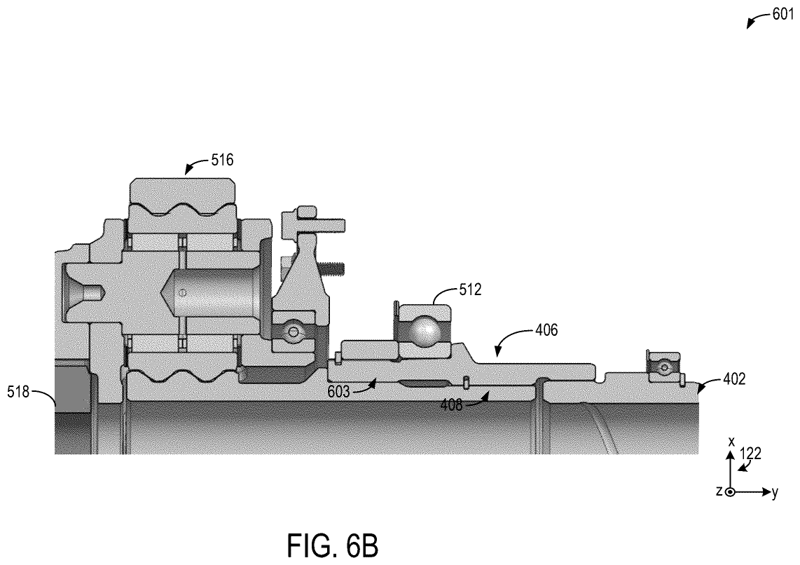

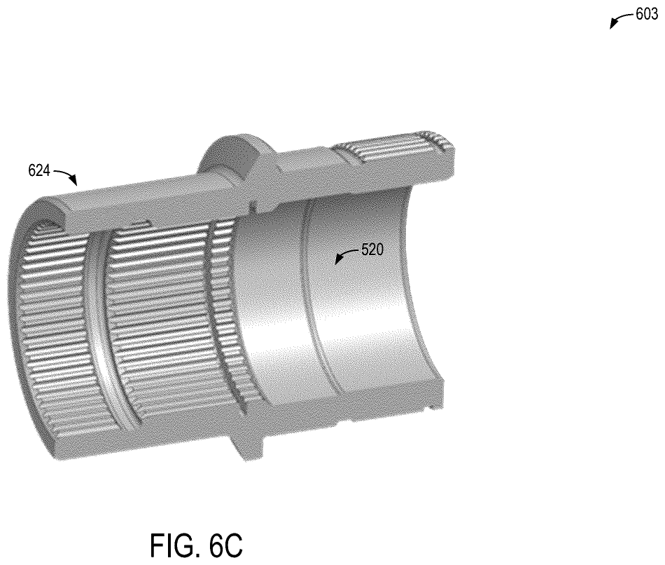

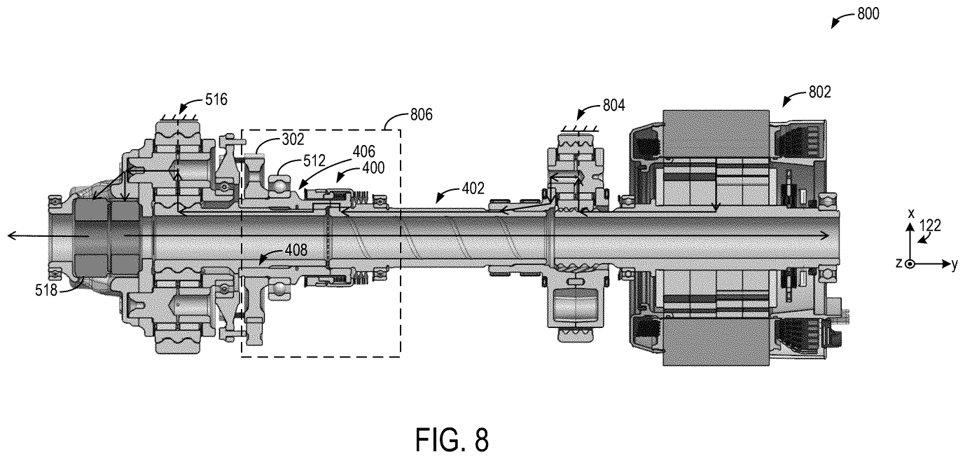

FIGS. 5A, 5B, and 6A depict a first variant 500, a second variant 501, and a third variant 600 of a parking and disconnect system that may integrated in a line of axles, the line of axles including a first transmission, a second transmission, a third transmission, and a fourth transmission. Each of the first transmission, the second transmission, the third transmission, and the fourth transmission include an electric motor (not shown) positioned on one side of a respective transmission, a position of the electric motor being the same for each of the first transmission, the second transmission, the third transmission, and the fourth transmission, the electric motor being rotationally coupled to the transmission shaft 402, a first planetary gearset (not shown) being coupled to the transmission shaft and being positioned between the electric motor (not shown) and a bearing 512 coupled to the sun gear shaft 408, the adaptor shaft 406 that circumferentially surrounds the transmission shaft at one end of the adaptor shaft and surrounds the sun gear shaft at another end of the adaptor shaft, and a second planetary gearset 516 being positioned between the bearing 512 and a differential 518 coupled to the sun gear shaft. An example of the axle system arrangement with the second variant 501 of the parking and disconnect system is depicted in FIG. 8.

The first transmission includes a parking and disconnect system similar to the first variant 500 depicted in FIG. 5A. The second transmission includes a parking and disconnect system similar to the second variant 501 depicted in FIG. 5B. The third transmission includes a parking and disconnect system similar to the third variant 600 depicted in FIG. 6A. The fourth transmission does not include the parking and disconnect system and instead, includes a portion of an axle arrangement similar to the fourth variant 601 depicted in FIG. 6B. The fourth variant 601 includes a portion of an axle arrangement, the portion of the axle arrangement including the transmission shaft 402, the adaptor shaft 406, and the sun gear shaft 408, the adaptor shaft circumferentially surrounding the transmission shaft at one end of the adaptor shaft and the sun gear shaft at another end of the adaptor shaft. The adaptor shaft 406 comprises an internal splined portion and an internal non-splined portion.

The differential 518 is positioned at one end of the sun gear shaft 408, the end being the opposing end wherefrom the adaptor shaft circumferentially surrounds the sun gear shaft. A second planetary gearset 516 is coupled to the sun gear shaft 408 and positioned between the differential 518 (e.g. to the right of the differential 518) and the bearing 512. Each of the first variant 500, the second variant 501, and the third variant 600 of the parking and disconnect system and the fourth variant 601 include the portion of the axle arrangement depicted in the fourth variant 601 of FIG. 6B. The first variant 500, the second variant 501, and the third variant 600 differ from fourth variant 601 due to including additional components from the park and disconnect system according to embodiments described herein.

FIG. 5A shows the first variant 500 of the parking and disconnect system according to embodiments described herein. The first variant 500 of the parking and disconnect system does not include the parking system described herein and does include the disconnect system 400 described herein. The first variant 500 may be arranged with a washer and snap rings instead of the parking system. As such, the disconnect system 400 is coupled to both the transmission shaft 402 and the adaptor shaft 406. Further, the disconnect system 400 is positioned between a first planetary gearset (not shown) and the bearing 512.

FIG. 5B shows a second variant 501 of the parking and disconnect system according to embodiments described herein. The second variant 501 includes both the parking system, including the park gear 302, and the disconnect system 400. Accordingly, the parking system is positioned between the bearing 512 and the disconnect system 400 and the disconnect system is positioned between the parking system and the first planetary gearset (not shown). The adaptor shaft 406 may be one of a first adaptor shaft 503 and a second adaptor shaft 603. Both FIGS. 5A and 5B may be configured with a first adaptor shaft 503, as shown in FIG. 5C, that enables the axle system to be configured with a disconnect system. The first adaptor shaft 503 includes a first portion 524 that is an internal splined portion and a second portion 520 that is internal non-splined portion.

FIG. 6A shows the third variant 600 of the parking and disconnect system according to embodiments described herein. The third variant 600 of the parking and disconnect system includes the parking system described herein and does not include the disconnect system 400 described herein. As such, the third variant 600 of the parking and disconnect system includes a parking system coupled to the sun gear shaft 408 and the adaptor shaft 406 and positioned between the first planetary gearset (not shown) and the bearing 512. Both the third variant 600 and the fourth variant 601 may be arranged with a washer and snap rings instead of the parking system. Further, both FIGS. 6A and 6B may be configured with a second adaptor shaft 603, as shown in FIG. 6C, that enables the axle system to be configured without the disconnect system 400. The second adaptor shaft 603 includes a first portion 624 that is an internal splined portion and the second portion 520. The internal splined portion (e.g., first portion 524) of the first adaptor shaft 503 is shorter than the internal splined portion (e.g., first portion 624) of the second adaptor shaft 603.

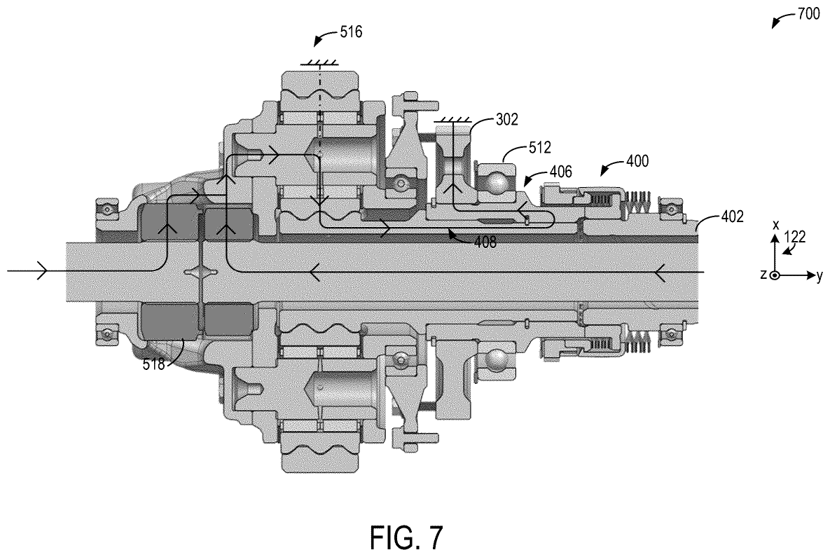

FIG. 7 shows an example of a power path 700 wherein torque is transmitted from the front wheels of a vehicle to the parking system to activate the parking system. Components included in the parking and disconnect system of FIG. 5B may be omitted for brevity. Torque is transmitted from the passenger side wheel to the differential 518, and from the differential 518 to the second planetary gearset 516. Additionally, torque is transmitted from the driver side wheel to the differential 518, and from the differential 518 to the second planetary gearset 516. Torque from both the driver side wheel and the passenger side wheel is transmitted from the second planetary gearset 516 to the sun gear shaft 408, from the sun gear shaft to the adaptor shaft 406, and from the adaptor shaft to the park gear 302.

A disconnect function of the disconnect system described herein with respect to FIG. 4 does not affect the park lock function of the parking system since both the disconnect system 400 and the parking system are connected to a sun gear. The park gear 302 is positioned between the wheels and the disconnect system. When a park pawl (e.g. park pawl 208) is engaged with a park gear 302, a final drive ratio is locked, preventing the wheels from turning regardless of whether the disconnect system is open.

FIG. 8 shows an example of an electric axle system 800, which may be a front axle. The electric axle system 800 includes an electric motor 802 rotationally coupled to the transmission shaft 402, the transmission shaft being coupled to a first planetary gearset 804, the adaptor shaft 406 coupled to the transmission shaft at one end of the adaptor shaft and coupled to a sun gear shaft 408 via splines at another end of the adaptor shaft, a parking and disconnect system 806 comprising one of a parking system and a disconnect system 400 or both of the parking system and the disconnect system, an actuator motor 202 electrically coupled to one of the parking system and the disconnect system or both of the parking system and the disconnect system, wherein counter clockwise rotation of the actuator motor (e.g. rotation in a first direction) activates the parking system and counter clockwise rotation of the actuator motor (e.g., rotation in a second direction) activates the disconnect system, and the second planetary gearset 516 coupled to a differential 518 at another end of the sun gear shaft. The electric axle system 800 includes the parking and disconnect system 806 described in FIG. 5B. However, the parking and disconnect system 806 may alternatively include the portions of the electric axle described in FIGS. 5A, 6A, and 6B.

The electric axle system 800 depicts an example power path wherein the disconnect system 400 is not activated and torque is transmitted to the front wheels of the vehicle. In particular, torque is transmitted from the motor 802 to the transmission shaft 402, from the transmission shaft 402 to the first planetary gearset 804, from the first planetary gearset to the transmission shaft 402, from the transmission shaft 402 to the dog clutch 410, from the dog clutch 410 to the adaptor shaft 406, from the adaptor shaft 406 to the sun gear shaft 408, from the sun gear shaft 408 to the second planetary gearset 516, from the second planetary gearset 516 to the differential 518, and from the differential to each of the passenger side wheel (e.g. on the left) and the driver side wheel (e.g., on the right).

The technical effect of a parking and disconnect system that includes one of a parking system and a disconnect system, or both a parking system and a disconnect system is that spacial efficiency of the transmission is increased.

The disclosure also provides support for a parking and disconnect system, comprising: an actuator motor coupled to a motor shaft, the motor shaft being coupled to a first bearing positioned at one end of the motor shaft, a first needle one-way clutch, a first pinion gear, a second pinion gear, and a second needle one-way clutch positioned at another end of the motor shaft, wherein the first pinion gear is engaged with a first gear and the second pinion gear is engaged with an idler gear, one of a parking system and a disconnect system or both of the parking system and the disconnect system, wherein the parking system is engaged with the first gear and the disconnect system is engaged with the idler gear, the parking system comprising a barrel cam coupled to a park pawl cone via a ratchet spring and rod, a park gear, and a park pawl coupled to the park pawl cone wherein adjustment of a position of the park pawl cone engages the park pawl and the park gear, the disconnect system comprising a second gear, a dog clutch, and an actuator that engages and disengages the dog clutch, and wherein the actuator motor rotates the motor shaft in a first direction to activate the parking system and the actuator motor rotates the motor shaft in a second direction to activate the disconnect system, the first direction being opposite from the second direction. In a first example of the system, actuation of the parking system does not affect actuation of the disconnect system. In a second example of the system, optionally including the first example, the first bearing is positioned beside the actuator motor, the first needle one-way clutch is positioned between the actuator motor and the first pinion gear, the first pinion gear is positioned between the first needle one-way clutch and the second pinion gear, and the second pinion gear is positioned between the first pinion gear and the second needle one-way clutch. In a third example of the system, optionally including one or both of the first and second examples, the first needle one-way clutch is positioned relative to the first pinion gear on the motor shaft to enable the first pinion gear to rotate in only the first direction and the second needle one-way clutch is positioned relative to the second pinion gear on the motor shaft to enable the second pinion gear to rotate in only the second direction. In a fourth example of the system, optionally including one or more or each of the first through third examples, the first pinion gear is engaged with the first gear to transmit torque to the parking system via the actuator motor and the second pinion gear is engaged with the idler gear to transmit torque to the disconnect system via the actuator motor. In a fifth example of the system, optionally including one or more or each of the first through fourth examples, one end of the second gear functions as a gear cam and another end of the second gear function as a face cam. In a sixth example of the system, optionally including one or more or each of the first through fifth examples, in response to the motor shaft rotating in the first direction, the parking system alternates between being activated and deactivated during a rotation cycle of the motor shaft. In a seventh example of the system, optionally including one or more or each of the first through sixth examples, in response to the motor shaft rotating in the second direction, the disconnect system alternates between being activated and deactivated during the rotation cycle of the motor shaft. In an eighth example of the system, optionally including one or more or each of the first through seventh examples, the rotation cycle is a duration of time wherein the motor shaft is rotating in one of the first direction and the second direction.

The disclosure also provides support for an electric axle system, comprising: an electric motor rotationally coupled to a transmission shaft, the transmission shaft being coupled to a first planetary gearset, an adaptor shaft coupled to the transmission shaft at one end of the adaptor shaft and coupled to a sun gear shaft via splines at another end of the adaptor shaft, a parking and disconnect system comprising one of a parking system and a disconnect system or both of the parking system and the disconnect system, an actuator motor electrically coupled to one of the parking system and the disconnect system or both of the parking system and the disconnect system, wherein rotation in a first direction of the actuator motor activates the parking system and rotation in a second, opposite, direction of the actuator motor activates the disconnect system, and a second planetary gearset coupled to a differential at another end of the sun gear shaft. In a first example of the system, the adaptor shaft comprises an internal splined portion and an internal non-splined portion and the adaptor shaft is one of a first adaptor shaft and a second adaptor shaft, the first adaptor shaft being integrated in the electric axle system with the disconnect system and the second adaptor shaft being integrated in the electric axle system without the disconnect system. In a second example of the system, optionally including the first example, the internal splined portion of the first adaptor shaft is shorter than the internal splined portion of the second adaptor shaft. In a third example of the system, optionally including one or both of the first and second examples, the adaptor shaft circumferentially surrounds one end of the sun gear shaft and one end of the transmission shaft. In a fourth example of the system, optionally including one or more or each of the first through third examples, the disconnect system is positioned between the first planetary gearset and the parking system and the disconnect system and the disconnect system is coupled to the transmission shaft at one end of the transmission shaft and the sun gear shaft at one end of sun gear shaft via the adaptor shaft. In a fifth example of the system, optionally including one or more or each of the first through fourth examples, the parking system is coupled to both of the adaptor shaft and the sun gear shaft.

The disclosure also provides support for a line of axle systems, comprising: a first transmission, a second transmission, a third transmission, and a fourth transmission, each of the first transmission, the second transmission, the third transmission, and the fourth transmission comprising: an electric motor positioned on one side of a respective transmission, a position of the electric motor being the same for each of the first transmission, the second transmission, the third transmission, and the fourth transmission, the electric motor being rotationally coupled to a transmission shaft, a first planetary gearset being coupled to the transmission shaft and being positioned between the electric motor and a bearing coupled to a sun gear shaft, an adaptor shaft that circumferentially surrounds the transmission shaft at one end of the adaptor shaft and surrounds the sun gear shaft at another end of the adaptor shaft, and a second planetary gearset being positioned between the bearing and a differential coupled to the sun gear shaft. In a first example of the system, the first transmission comprises a parking and disconnect system, the parking and disconnect system not comprising a parking system and comprising a disconnect system, the disconnect system being coupled to both of the transmission shaft and the sun gear shaft and being positioned between the first planetary gearset and the bearing. In a second example of the system, optionally including the first example, the second transmission comprises the parking and disconnect system, the parking and disconnect system comprising both of the parking system and the disconnect system such that the parking system is positioned between the bearing and the disconnect system and the disconnect system is positioned between the parking system and the first planetary gearset. In a third example of the system, optionally including one or both of the first and second examples, the third transmission comprises the parking and disconnect system, the parking and disconnect system comprising a parking system coupled to the sun gear shaft and positioned between the first planetary gearset and the bearing and not comprising a disconnect system. In a fourth example of the system, optionally including one or more or each of the first through third examples, the fourth transmission does not comprise the parking and disconnect system.

While various embodiments have been described above, it should be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive.

Note that the example control and estimation routines included herein can be used with various powertrain and/or vehicle system configurations. The control methods and routines disclosed herein may be stored as executable instructions in non-transitory memory and may be carried out by the control system including the controller in combination with the various sensors, actuators, and other vehicle hardware. Further, portions of the methods may be physical actions taken in the real world to change a state of a device. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example examples described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the vehicle control system, where the described actions are carried out by executing the instructions in a system including the various hardware components in combination with the electronic controller. One or more of the method steps described herein may be omitted if desired.

It will be appreciated that the configurations and routines disclosed herein are exemplary in nature, and that these specific examples are not to be considered in a limiting sense, because numerous variations are possible. For example, the above technology can be applied to powertrains that include different types of propulsion sources including different types of electric machines and transmissions. The subject matter of the present disclosure includes all novel and non-obvious combinations and sub-combinations of the various systems and configurations, and other features, functions, and/or properties disclosed herein.

The following paragraphs particularly point out certain combinations and sub-combinations regarded as novel and non-obvious. These paragraphs may refer to “an” element or “a first” element or the equivalent thereof. Such paragraphs should be understood to include incorporation of one or more such elements, neither requiring nor excluding two or more such elements. Other combinations and sub-combinations of the disclosed features, functions, elements, and/or properties may be claimed, whether broader, narrower, equal, or different in scope to the original paragraphs, also are regarded as included within the subject matter of the present disclosure.

In an example, an axle is coupled with an electromechanical actuator such as a motor, for engaging, separately, each of a parking brake and a clutch. The clutch may disengage the axle from a prime mover, such as an engine, another motor, etc. The electromechanical actuator (which in an example is the motor), may move (e.g., rotate) only in one direction, or move bi-directionally. In an alternative embodiment, separate motors are used for the parking system and the clutch, on the common axle.

1. A parking and disconnect system, comprising:
an actuator motor coupled to a motor shaft, the motor shaft being coupled to a first bearing positioned at one end of the motor shaft, a first needle one-way clutch, a first pinion gear, a second pinion gear, and a second needle one-way clutch positioned at another end of the motor shaft;
wherein the first pinion gear is engaged with a first gear and the second pinion gear is engaged with an idler gear;
one of a parking system and a disconnect system or both of the parking system and the disconnect system, wherein the parking system is engaged with the first gear and the disconnect system is engaged with the idler gear;
the parking system comprising a barrel cam coupled to a park pawl cone via a ratchet spring and rod, a park gear, and a park pawl coupled to the park pawl cone wherein adjustment of a position of the park pawl cone engages the park pawl and the park gear;
the disconnect system comprising a second gear, a dog clutch, and an actuator that engages and disengages the dog clutch; and
wherein the actuator motor rotates the motor shaft in a first direction to activate the parking system and the actuator motor rotates the motor shaft in a second direction to activate the disconnect system, the first direction being opposite from the second direction.

2. The parking and disconnect system of claim 1, wherein actuation of the parking system does not affect actuation of the disconnect system.

3. The parking and disconnect system of claim 1, wherein the first bearing is positioned beside the actuator motor, the first needle one-way clutch is positioned between the actuator motor and the first pinion gear, the first pinion gear is positioned between the first needle one-way clutch and the second pinion gear, and the second pinion gear is positioned between the first pinion gear and the second needle one-way clutch.

4. The parking and disconnect system of claim 1, wherein the first needle one-way clutch is positioned relative to the first pinion gear on the motor shaft to enable the first pinion gear to rotate in only the first direction and the second needle one-way clutch is positioned relative to the second pinion gear on the motor shaft to enable the second pinion gear to rotate in only the second direction.

5. The parking and disconnect system of claim 1, wherein the first pinion gear is engaged with the first gear to transmit torque to the parking system via the actuator motor and the second pinion gear is engaged with the idler gear to transmit torque to the disconnect system via the actuator motor.

6. The parking and disconnect system of claim 1, wherein one end of the second gear functions as a gear cam and another end of the second gear function as a face cam.

7. The parking and disconnect system of claim 1, wherein in response to the motor shaft rotating in the first direction, the parking system alternates between being activated and deactivated during a rotation cycle of the motor shaft.

8. The parking and disconnect system of claim 7, wherein in response to the motor shaft rotating in the second direction, the disconnect system alternates between being activated and deactivated during the rotation cycle of the motor shaft.

9. The parking and disconnect system of claim 8, wherein the rotation cycle is a duration of time wherein the motor shaft is rotating in one of the first direction and the second direction.

10. An electric axle system, comprising:
an electric motor rotationally coupled to a transmission shaft, the transmission shaft being coupled to a first planetary gearset;
an adaptor shaft coupled to the transmission shaft at one end of the adaptor shaft and coupled to a sun gear shaft via splines at another end of the adaptor shaft;
a parking and/or disconnect system comprising one of a parking system and a disconnect system or both of the parking system and the disconnect system,
an actuator motor electrically coupled to one of the parking system and the disconnect system or both of the parking system and the disconnect system;
wherein rotation in a first direction of the actuator motor activates the parking system and rotation in a second, opposite, direction of the actuator motor activates the disconnect system; and
a second planetary gearset coupled to a differential at another end of the sun gear shaft.

11. The electric axle system of claim 10, wherein the adaptor shaft comprises an internal splined portion and an internal non-splined portion and the adaptor shaft is one of a first adaptor shaft and a second adaptor shaft, the first adaptor shaft being integrated in the electric axle system with the disconnect system and the second adaptor shaft being integrated in the electric axle system without the disconnect system.

12. The electric axle system of claim 11, wherein the internal splined portion of the first adaptor shaft is shorter than the internal splined portion of the second adaptor shaft.

13. The electric axle system of claim 11, wherein the adaptor shaft circumferentially surrounds one end of the sun gear shaft and one end of the transmission shaft.

14. The electric axle system of claim 10, wherein the disconnect system is positioned between the first planetary gearset and the parking system and the disconnect system and the disconnect system is coupled to the transmission shaft at one end of the transmission shaft and the sun gear shaft at one end of sun gear shaft via the adaptor shaft.

15. The electric axle system of claim 10, wherein the parking system is coupled to both of the adaptor shaft and the sun gear shaft.

16. A line of axle systems, comprising:
a first transmission, a second transmission, a third transmission, and a fourth transmission, each of the first transmission, the second transmission, the third transmission, and the fourth transmission comprising:
an electric motor positioned on one side of a respective transmission, a position of the electric motor being the same for each of the first transmission, the second transmission, the third transmission, and the fourth transmission, the electric motor being rotationally coupled to a transmission shaft;
a first planetary gearset being coupled to the transmission shaft and being positioned between the electric motor and a bearing coupled to a sun gear shaft;
an adaptor shaft that circumferentially surrounds the transmission shaft at one end of the adaptor shaft and surrounds the sun gear shaft at another end of the adaptor shaft; and
a second planetary gearset being positioned between the bearing and a differential coupled to the sun gear shaft.

17. The line of axle systems of claim 16, wherein the first transmission comprises a parking and disconnect system, the parking and disconnect system not comprising a parking system and comprising a disconnect system, the disconnect system being coupled to both of the transmission shaft and the sun gear shaft and being positioned between the first planetary gearset and the bearing.

18. The line of axle system of claim 17, wherein the second transmission comprises the parking and disconnect system, the parking and disconnect system comprising both of the parking system and the disconnect system such that the parking system is positioned between the bearing and the disconnect system and the disconnect system is positioned between the parking system and the first planetary gearset.

19. The line of electric axles of claim 18, wherein the third transmission comprises the parking and disconnect system, the parking and disconnect system comprising a parking system coupled to the sun gear shaft and positioned between the first planetary gearset and the bearing and not comprising a disconnect system.

20. The line of electric axles of claim 19, wherein the fourth transmission does not comprise the parking and disconnect system.
